(19) United States
(12) Patent Application Publication
(10) Pub. No.: US 2018/0119761 A1
(43) Pub. Date: May 3, 2018

(54) Wear Adjustment Device for a Disc Brake

(71) Applicant: KNORR-BREMSE Systeme fuer Nutzfahrzeuge GmbH, Muenchen (DE)

(72) Inventor: Johann BAUMGARTNER, Moosburg (DE)

(21) Appl. No.: 15/858,552

(22) Filed: Dec. 29, 2017

Related U.S. Application Data
(63) Continuation of application No. PCT/EP2016/065267, filed on Jun. 30, 2016.

(30) Foreign Application Priority Data
Jul. 2, 2015 (DE) 10 2015 110 676.0

(51) Int. Cl. F16D 65/56; F16D 55/22

(52) U.S. Cl. CPC F16D 65/567; F16D 2125/06; F16D 55/22

(57) ABSTRACT

A readjustment device for a pneumatically actuatable disc brake for a vehicle is designed to compensate wear between a brake pad and/or a brake disc. The readjustment device has: a pneumatic actuator, which has a cylinder, into which an axially movable piston is inserted, to which compressed air can be applied and which can be moved in a first direction by application of compressed air; a non-self-locking threaded drive, which has a threaded nut and a threaded shaft, wherein the piston is coupled to the threaded nut in a rotationally fixed manner and wherein the threaded shaft rotatably extends through the threaded nut. The readjustment device has at least one restoring spring by which the piston can be moved in the cylinder in a second direction opposite the first direction such that the readjustment device performs an advancing stroke as a result of application of compressed air to the piston and performs a restoring stroke in a spring-actuated manner as a result of the spring force of the at least one restoring spring.

### CROSS REFERENCE TO RELATED APPLICATIONS

This application is a continuation of PCT International Application No. PCT/EP2016/065267, filed Jun. 30, 2016, which claims priority under 35 U.S.C. § 119 from German Patent Application No. 10 2015 110 676.0, filed Jul. 2, 2015, the entire disclosures of which are herein expressly incorporated by reference.

### BACKGROUND AND SUMMARY OF THE INVENTION

The present invention relates to a readjustment device for a pneumatically actuable disc brake.

Readjustment devices which are actuated mechanically by means of an application device, for example a rotary lever, and which are used for the readjustment of brake pads of pneumatically actuable disc brakes for a vehicle for the purposes of compensating brake pad and brake disc wear, are widely known from the prior art. Such mechanically actuated readjustment devices have in themselves proven successful, but often have the disadvantage of a relatively large structural space requirement. Furthermore, in the case of such mechanically actuated readjustment devices, the activation of the readjustment function is dependent on the brake actuation, such that a readjustment movement can take place only during the actuation of the service brake.

A readjustment device which is activatable independently of the brake actuation device because it is pneumatically actuated is described in the generic EP 1 546 571 B1 reference. Despite the smaller structural space in relation to many conventional mechanical readjustment devices, which also permits installation in the caliper rear section of the disc brake, said solution has not hitherto been realized in series applications. A disadvantage of the solution according to EP 1 546 571 B1 is that the exact air clearance adjustment is still relatively intensely affected by possible tolerances.

The invention is therefore based on the object of providing a pneumatic readjustment device, which is activatable independently of the brake actuating device, for a disc brake, which readjustment device at least reduces the abovementioned disadvantages of the generic prior art.

The invention achieves the object by providing a readjustment device for a pneumatically actuable disc brake for a vehicle, which readjustment device is designed for compensating wear between a brake pad or multiple brake pads and/or a brake disc. The readjustment device has at least the following: a pneumatic actuator device which has a cylinder into which there is inserted an axially displaceable piston which can be acted on with compressed air and which is movable in a first direction by being acted on with compressed air; a threaded drive of non-self-locking design which has a threaded nut and a threaded shaft; wherein the piston is coupled rotationally conjointly to the threaded nut, and wherein the threaded shaft extends rotatably through the threaded nut; wherein at least one resetting spring is provided by which the piston is movable in the cylinder in a second direction which is opposite to the first direction. The readjustment device is designed such that an advancing stroke can be performed as a result of the piston being acted on with compressed air, and a resetting stroke can be performed in spring-actuated fashion owing to the spring force of the at least one resetting spring. Since, in addition to an advancing stroke, it is also possible for a resetting stroke to be performed with a defined magnitude, precise air clearance setting is facilitated.

Below, an “air clearance” refers to the spacing between brake pad and brake disc in the released state of the brake. Here, a distinction is made between the “design air clearance”, that is to say the nominal, theoretical air clearance which is defined during the course of the structural design of a disc brake, and the “actual air clearance”, the magnitude of which can be measured on a cold disc brake between brake pad and brake disc and which is subject to tolerances, such that the magnitude thereof deviates from the magnitude of the design air clearance. If only the expression “air clearance” is used, this means the “actual air clearance”. Otherwise, the expression “design air clearance” is used.

In a preferred embodiment, the magnitude of the resetting stroke of the readjustment device is determined by a defined spacing h between two components or two geometry formations of the readjustment device, wherein the spacing h is determined in a defined operating state of the readjustment device. Thus, the magnitude of the design air clearance of the readjustment device or of the disc brake is defined by a spacing—that is to say a directly measurable value—of two components that must be manufacturable with high precision, or by the insertion or mounting of said components into or onto geometry formations of other components, which can likewise be manufactured with high precision. In this way, the tolerance-increasing influence of only indirectly measurable component characteristic variables, such as for example a spring characteristic curve etc., on the resetting stroke and thus on the magnitude of the air clearance of the readjustment device is particularly advantageously reduced.

Such setting of the resetting stroke and thus of the design air clearance of the readjustment device has a particularly advantageous effect if the spacing to be defined is determined in an easily settable operating state of the readjustment device. Such an operating state is easily and thus advantageously defined in that, in said operating state, the biting point of a brake pad of the disc brake is reached by the readjustment device, at which biting point the brake pad is caused by the readjustment device to just make contact with the brake disc of the disc brake, such that the braking action just starts to take effect.

By means of the pneumatic actuator device, the readjustment device can advantageously be caused to perform a function independently of the brake actuation. For this purpose, a load is exerted using compressed air. The threaded drive that is provided converts a translational movement of the piston into a rotational movement of the threaded shaft in a structural-space-saving and thus advantageous manner.

In one advantageous variant, the threaded shaft has a spline toothing section. Said spline toothing section is operatively connected to a spline toothing hub in a drive disc. In this way, a positively locking shaft-hub connection which is of structural-space-saving design and which is thus advantageously axially displaceable under load is formed.

In a further advantageous variant, the threaded shaft of the readjustment device furthermore preferably has a bearing section by means of which the threaded shaft is mounted rotatably in the brake caliper by means of a bearing, in particular a double-acting axial needle-roller bearing. Furthermore, the threaded shaft of the readjustment device preferably has a floating bearing which is formed by two axial bearing discs. Through the use of an axial needle-roller bearing or axial bearing discs which are of particularly narrow construction, the bearing points of the threaded shaft are of particularly structural-space-saving and thus advantageous design.

The piston preferably has an unlockable rotation prevention device which permits an axial displacement of the piston. By means of this advantageous unlockable rotation prevention device, the readjustment device can be easily moved into a basic position after the change of worn brake pads and/or of a worn brake disc, without the kinematics of the readjustment device having to be correspondingly designed for this purpose or a specific torque path having to be provided in the readjustment device for this purpose. Structural space is advantageously saved in this way.

The piston furthermore preferably has a stop ring preferably in the region of the inner side of a free end of a piston skirt. The stop ring is preferably inserted into a groove and thereby fastened in positively locking fashion to the piston. By virtue of the piston being designed with a piston skirt, the piston is guided securely and with low friction and thus in an advantageous manner in the cylinder. Furthermore, functional components of the readjustment device can be arranged in a structural-space-saving and thus likewise advantageous manner on an inner side of the piston.

In a further advantageous design variant, the readjustment device has at least one output wheel. The output wheel has an internal thread which can interact with an external thread of the threaded spindle. In this way, a second threaded drive is formed which converts the torque of the threaded shaft into a translationally acting (movement and) force, which can be transmitted for example via a thrust piece to the at least one brake pad in order that the latter performs an advancing stroke or a resetting stroke. For this purpose, the thrust piece is connected to the brake pad such that it can push the latter forward and back. In this way, a structural-space-saving and thus advantageous second threaded drive is created which converts the torque of the threaded shaft into a translationally acting movement and force which acts on the brake pads and on the brake disc of the disc brake.

According to a further advantageous variant, the readjustment device furthermore has a sleeve or a spring sleeve by means of which the introduced torque of the threaded shaft is transmitted to output elements via transmission elements, for example expediently to an internal profile of the output wheel. In this way, a rotationally conjoint coupling of the sleeve to the output wheel is formed. Furthermore, this type of coupling forms a simple cardanic joint, whereby it is advantageously possible for tilting or precession movements of a threaded spindle which converts the torque into a translationally acting force to be compensated.

The readjustment device then preferably has a first ball ramp coupling and furthermore preferably a second ball ramp coupling. Through the use of ball ramp couplings, it is possible for different torque paths, such are required for the functioning of the readjustment device, to be switched in a simple and structural-space-saving and thus advantageous manner.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a front view of the readjustment device in section, installed in an only partially illustrated brake caliper.

### DETAILED DESCRIPTION OF THE DRAWING

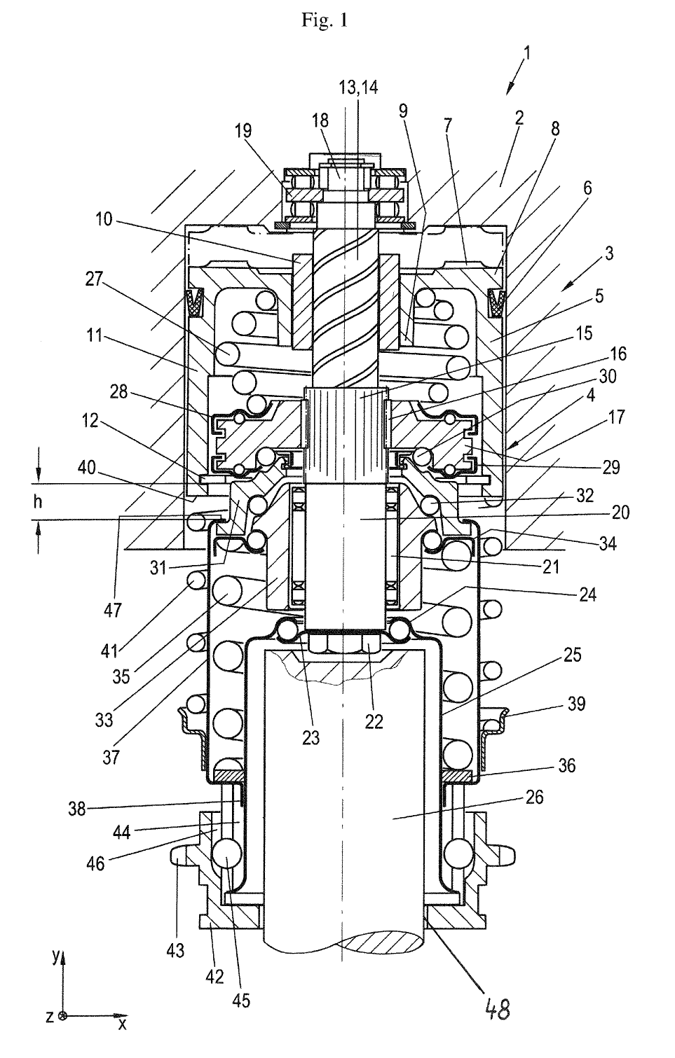

FIG. 1 shows a front view of the readjustment device in section. The readjustment device 1 is installed or installable in a brake caliper 2 of a disc brake (not otherwise illustrated here) which, aside from the readjustment device or several of the readjustment devices, may be constructed for example in the manner of EP 1 546 571 B1, that is to say has a pneumatically actuable application device for applying the brake during braking operations (not illustrated here).

The readjustment device 1 has a pneumatically actuable actuator device 3 (that is to say an actuator device that can be acted on with compressed air). In this way, the readjustment device 1 is advantageously activatable independently of a brake actuation. The pneumatically actuable actuator device 3 has a cylinder 4. Into the cylinder 4 there is inserted a piston 5 which is axially displaceable in the cylinder 4 and which can be acted on with compressed air. The piston 5 has a seal 6 which is inserted into a groove in the piston 5. The seal 6 seals off the chamber of the cylinder 4 above the seal 6, or in the negative y direction in relation to the coordinate system in FIG. 1, with respect to the surroundings. The action with compressed air may in turn be realized by means of a compressed-air generating system (not illustrated here) of a vehicle, which system is connected to the disc brake and is connected to control electronics for the control of the brake (not illustrated here).

The piston 5 has a piston crown 8. The piston crown 8 has an outer side which is formed in the direction of a stroke or pressure chamber of the cylinder 4, or in the positive y direction in relation to the coordinate system in FIG. 1. The piston crown 8 furthermore has an inner side which is formed in a direction averted from the stroke or pressure chamber of the cylinder 4, or in the negative y direction in relation to the coordinate system in FIG. 1.

The piston 5 has at least one or in this case several—in FIG. 1 upper—piston stops 7, which each extend in elevated fashion on the outer side of the piston crown 8 over the piston crown 8 in the positive y direction in relation to the coordinate system in FIG. 1, and which in this case are advantageously formed integrally on the piston 5.

The piston 5 furthermore has a centrally arranged collar 9, which extends in the negative y direction in relation to the coordinate system in FIG. 1. The piston 5 furthermore has a central bore which is delimited by the collar 9. A threaded nut 10 is inserted into the bore.

The piston 5 then preferably has an unlockable rotation prevention device (not illustrated here) which permits an axial displacement of the piston 5. By means of the unlockable rotation prevention device, the readjustment device 1 can be easily and advantageously moved into a basic position after the change of worn brake pads and/or of a worn brake disc, without the kinematics of the readjustment device 1 having to be correspondingly designed for this purpose or a specific torque path having to be provided in the readjustment device 1 for this purpose. Structural space is advantageously saved in this way.

The piston 5 furthermore has a stop ring 12 in the region of the inner side of the free end of a so-called piston skirt 11. The stop ring 12 is inserted into a groove and is thereby fastened in positively locking fashion to the piston 5. By virtue of the piston 5 being designed with a relatively long piston skirt 11, the piston 5 is guided securely and with low friction and thus in an advantageous manner in the cylinder 4. Furthermore, functional components of the readjustment device 1 can be arranged in a structural-space-saving and thus likewise advantageous manner on the inner side of the piston 5.

The piston 5 is coupled to a threaded drive 10, 13, 14 of non-self-locking design which has a threaded nut 10 and a threaded shaft 13. For this purpose, the threaded drive extends through a central opening of the piston 5.

The threaded shaft 13 has a threaded section 14. Said threaded section 14 is operatively connected to the threaded nut 10, which is extended through by the threaded section 14 of the threaded shaft 13. The threaded drive is formed in this way. The threaded nut is fixedly connected to the piston so as to be displaced in translational fashion together therewith during movements of the piston 5, wherein said threaded nut sets the threaded shaft 13 of the threaded drive of non-self-locking design in rotation. The threaded drive thus converts a translational movement of the piston 5 into a rotational movement of the threaded shaft 13 in a particularly structural-space-saving and thus advantageous manner.

The threaded shaft 13 furthermore has a bearing section 18 on one end thereof. Said bearing section 18 is in this case of multiply stepped form. The bearing section 18 is rotatably mounted in the brake caliper 2 by way of a bearing. The bearing bears against that end of the threaded shaft 13 which is averted from a brake pad (not illustrated here).

The bearing that is provided is preferably a double-acting bearing. It is particularly preferable for an axial needle-roller bearing, in particular a double-acting axial needle-roller bearing 19, to be used, by which the threaded shaft 13 is mounted rotatably in the brake caliper 2. The bearing section 18 is furthermore preferably of multiply stepped form.

The bearing, in this case the double-acting axial needle-roller bearing 19, thus forms a counterbearing for the threaded shaft 13. The brake caliper 2 has, for this purpose, a corresponding opening, in particular a housing bore, in which the double-acting axial needle-roller bearing 19 is inserted and fixed in an axial direction in the direction of the positive y direction in relation to the coordinate system in FIG. 1.

The double-acting axial needle-roller bearing 19 is fixed in an axial direction or in the negative y direction in relation to the coordinate system in FIG. 1 by means of a housing securing ring. Through the use of a double-acting axial needle-roller bearing 19, the fixed bearing of the threaded shaft 13 is of particularly structural-space-saving and thus advantageous design.

The threaded shaft 13 extends through the piston 5 proceeding from the bearing on/in the brake caliper 2. On that side of the piston 5 which is averted from the brake caliper 2, the threaded shaft 13 has a spline toothing section 15. Said spline toothing section 15 is operatively connected to a spline toothing hub 16 in a drive disc 17. In this way, a positively locking shaft-hub connection which is axially displaceable under load is formed in a structural-space-saving and thus advantageous manner.

The threaded shaft 13 furthermore has a freewheel section 20. The freewheel section 20 extends through the hub of a freewheel 21. The freewheel 21 may for example be designed as a clamping-roller freewheel.

The threaded shaft 13 has, on its end averted from the multiply stepped bearing section 18, an in this case axially central, internally threaded blind bore. A screw, in this case a polygonal screw 22, is inserted into the internally threaded blind bore. An axial bearing disc 23 is fastened to the threaded shaft 13 by means of the polygonal screw 22. The axial bearing disc 23 forms, together with a rolling body channel 24 and rolling bodies—in this case in the form of balls—an axial bearing which forms the floating bearing of the threaded shaft 13. Through the use of axial bearing discs 23 and 25 of particularly narrow construction, the floating bearing of the threaded shaft 13 is of particularly structural-space-saving and thus advantageous design.

The rolling body channel 24 is formed into a face side of a sleeve 25 by means of a deformation process. The sleeve 25 adjoins the threaded shaft 13 coaxially in the negative y direction in relation to the coordinate system in FIG. 1. The sleeve 25 has a bell-shaped cross section.

The readjustment device 1 furthermore has at least one threaded spindle 26. The threaded spindle 26 adjoins the threaded shaft 13 coaxially in the negative y direction in relation to the coordinate system in FIG. 1, and acts directly as a thrust piece or via a thrust piece on one of the brake pads (not illustrated here) of the disc brake. The threaded spindle 26 protrudes, with its end facing toward the threaded shaft 13, at least partially into the sleeve 25.

The readjustment device 1 preferably has at least one output wheel 42. The output wheel 42 has an internal thread 48 which is operatively connected to an external thread of the threaded spindle 26. In this way, a second threaded drive is formed, which converts the torque of the threaded shaft 13 into a translationally acting force, which acts for example via a thrust piece (not illustrated here) on the at least one brake pad and on the brake disc of the disc brake.

Alternatively, the output wheel 42 may also be connected rotationally conjointly to the threaded spindle 26. In such a situation, the second threaded drive is formed by the threaded spindle 26 and by an internal thread for example in a thrust piece (not illustrated here, see DE 10 2012 108 672 B3, FIG. 6, reference designation 6e) or the internal thread in a pad carrier plate of the brake pad or the internal thread in a further component (not illustrated here, see DE 10 2012 108 672 B3, FIG. 6, reference designation 8).

The output wheel 42 is optionally coupled to a synchronization device 43. The synchronization device 43, which is formed here by way of example as a sprocket toothing, which guides a wraparound drive with a chain for the synchronization of the rotational movement of the threaded spindle 26 with an optionally provided second threaded spindle (not illustrated), which can likewise act directly or via a thrust piece on the brake pad. Alternatively, other synchronization device 43 are also possible, for example an involute toothing, which then meshes with the toothing of an intermediate wheel, which is in turn operatively connected to a further output wheel 42. The output wheel 42 furthermore has an internal profile 46. The internal profile 46 is in this case designed for example in the manner of a toothing profile.

The sleeve 25 has, on its circumference, multiple output elements 44 which are each formed integrally on the sleeve 25. The output element 44 is in this case designed for example in the manner of a toothing profile.

A spring sleeve 37 is connected rotationally conjointly by means of a collar 38 to the sleeve 25. A torque of the threaded shaft 13, which torque is introduced into the spring sleeve 37, or via the collar 38, which forms the spring sleeve 37, also into the sleeve 25, is transmitted by the output elements 44 via transmission elements 45, which are formed in this case by way of example as balls, to the internal profile 46 of the output wheel 42.

In this way, a rotationally conjoint coupling of the sleeve 25 to the output wheel 42 is formed. Furthermore, this type of coupling forms a cardanic joint, whereby possible tilting or precession movements of the at least one threaded spindle 26, which converts the torque of the threaded shaft 13 into a translationally acting force by means of the thread xx of the output wheel 42, can advantageously be compensated.

The actuator device 3 has a first resetting spring 27. The first resetting spring 27 is designed as a helical torsion spring and as a double-cone or barrel spring, and accordingly has a progressive spring characteristic curve. The first resetting spring 27 is supported with its upper end, or its end in the positive y direction in relation to the coordinate system in FIG. 1, in a transition between the inner side of the piston crown 8 and the collar 9. The first resetting spring 27 is supported with its lower end on an upper bearing ring 28.

The upper bearing ring 28 forms, with the drive disc 17 and rolling bodies which are in this case in the form of balls, a first rolling bearing by means of which the drive disc 17 is rotatably mounted. The drive disc 17 has, on its upper face side or on its side in the positive y direction in relation to the coordinate system in FIG. 1, a corresponding channel in which the rolling bodies of the first rolling bearing of the drive disc 17 roll. The upper bearing ring 28 is fastened to the drive disc 17 at the circumference of the latter and, for this purpose, engages into a corresponding groove.

A second rolling bearing by which the drive disc 17 is rotatably mounted is formed by a lower bearing ring 29 and rolling bodies which are in this case likewise in the form of balls. The drive disc 17 has, on its lower face side or on its side in the negative y direction in relation to the coordinate system in FIG. 1, a corresponding channel in which the rolling bodies of the first rolling bearing of the drive disc 17 roll. The lower bearing ring 28 is fastened to the drive disc 17 at the circumference of the latter and, for this purpose, engages into a corresponding groove.

The lower bearing ring 28 is supported, in the operating state of the readjustment device 1 illustrated in FIG. 1, on the stop ring 12, or makes contact with the stop ring 12 such that the lower bearing ring 28 and the stop ring 12 just make contact. This operating state is defined in that, by means of the readjustment device, the brake pad or the brake pads of the disc brake have been caused to just bear against the brake disc, such that the biting point of the brake pad or of the brake pads has been reached.

The drive disc 17 has, on its lower face side, on its side in the negative y direction in relation to the coordinate system in FIG. 1, a cylindrical depression. The transition between the base of the depression and the side surface has a radius. The radius forms a raceway of the rolling bodies of a first ball ramp coupling 30. A counterpart raceway of the first ball ramp coupling 30 is formed by a conical projection of an output disc 31.

The drive disc 31 has a bell-shaped cross section. The drive disc 31 furthermore has a central bore through which the threaded shaft 13 extends. The output disc 31 and the threaded shaft 13 however have no direct torque-proof shaft-hub connection, such that the output disc 31 is rotatable independently of the rotational movement of the threaded shaft 13.

On its inner side, the bell-shaped output disc 31 has a radius. The radius forms a raceway of the rolling bodies of a second ball ramp coupling 32.

A counterpart raceway of the second ball ramp coupling 32 is formed by a conical projection of a freewheel outer ring 33. The freewheel outer ring 33 forms, together with the freewheel section 20 of the threaded shaft 13 and the freewheel 21, a coupling which acts only in one direction of rotation.

Through the use of ball ramp couplings 30, 32, it is possible for different torque paths, such are required for the function of the readjustment device 1 and will be discussed in more detail in the function description, to be switched easily and in a structural-space-saving and thus advantageous manner.

The freewheel outer ring 33 has a further radius on its outer circumferential surface. Said radius forms, with a centering ring 34 and rolling bodies which in this case are in the form of balls, a rolling bearing by means of which the freewheel outer ring 17 is rotatably mounted.

A preload spring 35 is supported on the centering ring 34. The preload spring 35 is a helical torsion spring with a cylindrical cross section. The preload spring 35 extends between the centering ring 34 and a further centering ring 36 which is arranged coaxially with respect to the threaded shaft 13 and, in relation to the centering ring 34, in the negative y direction in relation to the coordinate system in FIG. 1. The centering ring 36 is inserted into the spring sleeve 37.

The spring sleeve 37 engages with a projection 47 around a geometrically corresponding collar of the freewheel outer ring 33, and is connected rotationally conjointly to the freewheel outer ring 33. The spring sleeve 37 surrounds the preload spring 35 and forms, at its lower end or in the negative y direction in relation to the coordinate system in FIG. 1, an opening which has the encircling collar 38. The spring sleeve 37 is connected rotationally conjointly to the sleeve 25 by means of the collar 38.

The spring sleeve 37 has a centering ring 39 on its outer circumference. Between a circular-ring-shaped surface 40, which the piston 5 forms at its free end of the piston skirt 11, and the centering ring 39, the readjustment device 1 has a second resetting spring 41. The second resetting spring 41 is a helical torsion spring with cylindrical cross section.

The function of the readjustment device 1 will be discussed below. In the event of an axial displacement of the piston 5 as a result of acting pressure forces or resetting forces of the resetting springs 27, 41, the threaded shaft 13 is set in rotational motion by way of the threaded nut 10. Said rotational motion is transmitted firstly via the spline toothing section 15 of the threaded shaft 13 to the drive disc 17 and onward via the first ball ramp coupling 30 to the output disc 31, and secondly likewise, only in an advancing direction of rotation owing to the blocking action of the freewheel 21, to the output disc 31. From the output disc 31, the advancing or resetting rotational motion, depending on the stroke direction of the piston 5, is transmitted via the spring sleeve 25 or via the sleeve 25 to the output wheel 42 to the at least one threaded spindle 26, which rotational movement is, by way of a second threaded drive which is formed by the output wheel 42 and the threaded spindle 26, converted into a translationally acting force. The force acts, for example via a thrust piece, on the at least one brake pad and consequently on the brake disc of the disc brake.

The mode of operation of the readjustment device 1 will be discussed below on the basis of three operating states of the readjustment device 1:

(1) Air clearance correct
(2) Air clearance too large
(3) Air clearance too small
If the air clearance of the disc brake is correct, the advancing movement for a setting process of the readjustment device 1 is triggered by introducing compressed air into the cylinder 4 of the piston 5. The piston 5 is displaced downward, or in the direction of the negative y direction in relation to the coordinate system in FIG. 4, counter to the force of the first resetting spring 27 and of the second resetting spring 41, and in the process sets the threaded shaft 13 in an advancing rotational movement by means of the threaded section 14 or by means of the threaded drive 10, 14.

By way of the unidirectional clamping action of the freewheel 21 and furthermore by way of the ball ramp coupling 32 which is closed under the force of the preload spring 35, the rotational movement of the threaded shaft 13 is transmitted to the output disc 31, and from there via the spring sleeve 37, the sleeve 25 and the output wheel 42 to the at least one threaded spindle 26.

In this phase, the drive disc 17 does not yet transmit any torque, because it is still lying on the stop ring 12 of the piston 5, and the first ball ramp coupling 30 is thus still aerated.

In the event of a continued stroke movement of the piston 5 in the negative y direction, the stop ring 12 of the piston 5 lifts off from the lower bearing ring 29 of the drive disc 12. The first ball ramp coupling 30 is closed. At the same time, the movement of the at least one threaded spindle 26 is stopped by the reaction force that arises as a result of the brake pads bearing against a brake disc of the disc brake.

The piston 5 continues its stroke movement until the piston 5 reaches a lower stop or until the circular-ring-shaped surface 40, which the piston 5 forms at its free end of the piston skirt 11, abuts against the collar 47 of the spring sleeve 37.

The distance covered by the piston 5 from the moment at which the first ball ramp coupling 30 is closed, and at the same time the movement of the at least one threaded spindle 26 is stopped by the reaction force that arises as a result of the brake pads bearing against a brake disc of the disc brake, until the piston 5 abuts against the collar 47 of the spring sleeve 37 is the resetting stroke h of the readjustment device 1.

The magnitude of the resetting stroke of the readjustment device 1—and thus the magnitude of the air clearance of the disc brake—is accordingly advantageously given by a defined spacing h between two components or geometry formations 12, 47—that is to say the stop ring 12 of the piston 5 and the collar 47 of the spring sleeve 27—in a defined operating state of the readjustment device 1.

The defined operating state of the readjustment device 1 is characterized in that it is set by virtue of the biting point where the disc brake brake pads are caused to bear against the brake disc of the disc brake by the readjustment device 1. In this way, the magnitude of the air clearance is particularly advantageously afflicted only with low geometry tolerances of the components, or of the geometry formations of components, whose spacing defines the magnitude of the air clearance.

The drive disc 12 and the freewheel 21 remain in rotational motion, which is however not transmitted onward to the output disc 31 owing to the slipping of the first ball ramp coupling 30 and of the second ball ramp coupling 32. No further advancing movement is performed.

The resetting movement is performed by the aeration of the cylinder 4 of the piston 5. The piston 5 is displaced upward or in the positive y direction in relation to the coordinate system in FIG. 1 by the force of the resetting springs 27 and 41. As a result, the piston 5 sets the threaded shaft 13 in a resetting rotational motion by means of the threaded nut 10.

The resetting rotational motion of the threaded shaft 13 is transmitted by the output disc 31 by the spring sleeve 37 and the sleeve 25 to the at least one threaded spindle 26. The resetting rotational motion of the threaded shaft 13 is continued in the release direction of the freewheel 21 until the stop ring 12 of the piston 5 reaches the lower bearing ring 29 of the output disc 31, and thus the first ball ramp coupling 30 is aerated.

At this point, the setpoint air clearance of the disc brake has been reached. The further resetting rotational movement of the threaded shaft 13 is no longer transmitted to the at least one threaded spindle 26, because the freewheel 21 is acted on in the release direction, and the first ball ramp coupling 30 is aerated.

In the case of too large an air clearance, the advancing movement of the readjustment device 1 initially takes place as in the case of a correct air clearance.

Accordingly, the advancing movement for a setting process of the readjustment device 1 is triggered by an introduction of compressed air into the cylinder 4 of the piston 5. The piston 5 is displaced downward, or in the direction of the negative y direction in relation to the coordinate system in FIG. 4, counter to the force of the first resetting spring 27 and of the second resetting spring 41, and in the process sets the threaded shaft 13 in an advancing rotational movement by means of the threaded section 14 or by means of the threaded drive 10, 14.

By way of the unidirectional clamping action of the freewheel 21 and furthermore by way of the ball ramp coupling 32 which is closed under the force of the preload spring 35, the rotational movement of the threaded shaft 13 is transmitted to the output disc 31, and from there via the spring sleeve 37 and the sleeve 25 to the at least one threaded spindle 26.

In this phase, the drive disc 17 does not yet transmit any torque, because it is still lying on the stop ring 12 of the piston 5, and the first ball ramp coupling 30 is thus still aerated.

In the aerated state of the first ball ramp coupling 30, however, the set of balls of the first ball ramp coupling 30 is now held by a cage on the drive disc 17, and the channel situated in the drive disc 17 is lifted off from the balls. The stop ring 12 of the piston 5 lifts off from the stop surface on the drive disc 17. The first ball ramp coupling 30 is closed. The piston 5 continues its stroke movement.

Here, the setpoint air clearance is overshot. The advancing rotational movement of the at least one threaded spindle 26 is continued.

The compensation of the increased air clearance takes place in this phase.

The at least one threaded spindle 26 is stopped by the reaction force that arises as a result of the brake pads making contact. The piston 5 continues its stroke movement until it has reached the projection 47, which in this case has the function of a lower piston stop. The drive disc 17 and the freewheel 21 remain in rotational motion, which is however not transmitted onward to the output disc 31 owing to the slipping of the first ball ramp coupling 30 and of the second ball ramp coupling 32. Accordingly, no further advancing movement is performed.

The resetting movement is performed as described above in the functional example for a correct air clearance.

In the case of too small an air clearance, the advancing movement of the readjustment device 1 initially takes place as in the case of a correct air clearance.

Accordingly, the advancing movement for a setting process of the readjustment device 1 is triggered by an introduction of compressed air into the cylinder 4 of the piston 5. The piston 5 is displaced downward, or in the direction of the negative y direction in relation to the coordinate system in FIG. 4, counter to the force of the first resetting spring 27 and of the second resetting spring 41, and in the process sets the threaded shaft 13 in an advancing rotational movement by means of the threaded section 14 or by means of the threaded drive 10, 14.

By way of the unidirectional clamping action of the freewheel 21 and furthermore by way of the ball ramp coupling 32 which is closed under the force of the preload spring 35, the rotational movement of the threaded shaft 13 is transmitted to the output disc 31, and from there via the spring sleeve 37 and the sleeve 25 to the at least one threaded spindle 26.

In this phase, the drive disc 17 does not yet transmit any torque, because it is still lying on the stop ring 12 of the piston 5, and the first ball ramp coupling 30 is thus still aerated.

As a result of the air clearance being too small, the movement of the at least one threaded spindle 26 is blocked by the abutment of the brake pads against the brake disc before the stop ring 12 of the piston 5 lifts off from the lower bearing ring 29 of the drive disc 17.

In the presence of a blocked output disc 31, the rotational motion transmitted by means of the unidirectional clamping action of the freewheel 21 is not transmitted onward to the at least one threaded spindle 26, owing to the slipping of the second ball ramp coupling 32.

The compensation of the air clearance which is too small takes place in this phase.

The stop ring 12 of the piston 5 lifts off from the lower bearing ring 29 of the drive disc 17. The first ball ramp coupling 30 is closed. The piston 5 continues its stroke movement, has reached the projection 47, which in this case has the function of a lower piston stop. The drive disc 17 and the freewheel 21 remain in rotational motion, which is however not transmitted onward to the output disc 31 owing to the slipping of the first ball ramp coupling 30 and of the second ball ramp coupling 32. Accordingly, no further advancing movement is performed.

The resetting movement is performed as described above in the functional example for a correct air clearance.

The resetting movement of the readjustment device 1 after the exchange of worn brake pads back into a basic position is performed by unlocking the rotation prevention device of the piston 5 and by actuating the piston 5.

### LIST OF REFERENCE DESIGNATIONS

1 Readjustment device
2 Brake caliper
3 Actuator device
4 Cylinder
5 Piston
6 Seal
7 Piston stop
8 Piston crown
9 Collar
10 Threaded nut
11 Piston skirt
12 Stop ring
13 Threaded shaft
14 Threaded section
15 Spline toothing section
16 Spline toothing hub
17 Drive disc
18 Bearing section
19 Axial needle-roller bearing
20 Freewheel section
21 Freewheel
22 Hexagonal screw
23 Axial bearing disc
24 Rolling body channel
25 Sleeve
26 Threaded spindle
27 Resetting spring
28 Bearing ring, top
29 Bearing ring, bottom
30 Ball ramp coupling
31 Output disc
32 Ball ramp coupling
33 Freewheel outer ring
34 Centering ring
35 Preload spring
36 Centering ring
37 Spring sleeve
38 Collar
39 Centering ring
40 Circular-ring-shaped surface
41 Resetting spring
42 Output wheel
43 Synchronization device
44 Output elements
45 Transmission elements
46 Internal profile
47 Projection
48 Internal thread

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A readjustment device for a pneumatically actuable disc brake for a vehicle, which readjustment device compensates wear between a brake pad or multiple brake pads and/or a brake disc, wherein the readjustment device comprises:
a pneumatic actuator which has a cylinder;
an axially displaceable piston inserted into the cylinder, to which piston compressed air is suppliable and which is movable in a first direction by being acted on with compressed air, a threaded drive of non-self-locking design which has a threaded nut and a threaded shaft;
wherein the piston is coupled rotationally conjointly to the threaded nut, and further wherein the threaded shaft extends rotatably through the threaded nut;
at least one resetting spring by which the piston is movable in the cylinder in a second direction which is opposite to the first direction,
wherein the readjustment device is configured such that an advancing stroke occurs as a result of the piston being acted on with compressed air, and a resetting stroke occurs in spring-actuated fashion owing to the spring force of the at least one resetting spring.

2. The readjustment device as claimed in claim 1, wherein
a rotation of the threaded spindle in a first direction of rotation occurs as a result of the piston being acted on with compressed air, and
a rotation in a second direction of rotation opposite to the first direction of rotation occurs as a result of the piston being acted on with the spring force of the at least one resetting spring.

3. The readjustment device as claimed in claim 2, wherein
the advancing stroke and the resetting stroke of the threaded spindle is endable by switching of a coupling or of multiple couplings.

4. The readjustment device as claimed in claim 3, wherein
a magnitude of the resetting stroke of the readjustment device is determined by a defined spacing h between two components or two geometry formations of components of the readjustment device, wherein the spacing h is set in a defined operating state of the readjustment device.

5. The readjustment device as claimed in claim 4, wherein
the defined operating state is set by virtue of a biting point of a brake pad of the disc brake being reached.

6. The readjustment device as claimed in claim 5, wherein
the components or the geometry formations are a stop ring of the piston of the pneumatic actuator device and a collar of a spring sleeve.

7. The readjustment device as claimed in claim 4, wherein
the piston has multiple upper piston stops, and the piston stops each extend in elevated fashion over a piston crown and is/are preferably formed integrally on the piston.

8. The readjustment device as claimed in claim 7, the piston has a centrally arranged collar and/or a central bore.

9. The readjustment device as claimed in claim 8, wherein
the bore is extended through by the threaded nut, and
the threaded nut is coupled rotationally conjointly to the piston.

10. The readjustment device as claimed in claim 8, wherein
the piston has an unlockable rotation prevention device which permits an axial displacement of the piston.

11. The readjustment device as claimed in claim 10, wherein
the threaded shaft has a threaded section, and
the threaded section is operatively connected to the threaded nut, which is extended through by the threaded section of the threaded shaft.

12. The readjustment device as claimed in claim 11, wherein
the threaded section of the threaded shaft and the threaded nut each have a non-self-locking thread.

13. The readjustment device as claimed in claim 12, wherein
the threaded shaft further has a spline toothing section, wherein the spline toothing section is operatively connected to a spline toothing hub.

14. The readjustment device as claimed in claim 13, wherein
the readjustment device has a drive disc.

15. The readjustment device as claimed in claim 14, wherein
the drive disc has the spline toothing hub.

16. The readjustment device as claimed in claim 15, wherein
the threaded shaft is mounted, on a bearing, rotatably in the brake caliper of the disc brake.

17. The readjustment device as claimed in claim 16, wherein
the bearing is a double-acting axial needle-roller bearing.

18. The readjustment device as claimed in claim 17, wherein
the threaded shaft has a multiply stepped bearing section by which the threaded shaft is mounted, on the bearing, rotatably in the brake caliper of the disc brake.

19. The readjustment device as claimed in claim 16, wherein
the brake caliper has an opening in which the bearing is inserted and fixed in an axial direction.

20. The readjustment device as claimed in claim 19, wherein
the threaded shaft has a freewheel section, and
the freewheel section of the threaded shaft extends through a hub of a freewheel.

21. The readjustment device as claimed in claim 20, wherein
an axial bearing disc is fastened to the threaded shaft.

22. The readjustment device as claimed in claim 21, wherein
the axial bearing disc, together with a rolling body channel and rolling bodies, forms
an axial bearing, wherein the rolling body channel is formed into a face side of a sleeve by deformation.

23. The readjustment device as claimed in claim 22, wherein
the sleeve coaxially adjoins the threaded shaft.

24. The readjustment device as claimed in claim 23, wherein
the readjustment device has at least one threaded spindle, and
the threaded spindle protrudes, with an end facing toward the threaded shaft, at least partially into the sleeve.

25. The readjustment device as claimed in claim 24, wherein
the readjustment device has at least one output wheel.

26. The readjustment device as claimed in claim 25, wherein
the at least one output wheel has a synchronization device, and
the synchronization device is formed as a sprocket toothing or as an involute toothing.

27. The readjustment device as claimed in claim 26, wherein
the output wheel has an internal profile, and
the internal profile is a toothing profile.

28. The readjustment device as claimed in claim 27, wherein
the output wheel has an internal thread which is operatively connected to an external thread of the threaded spindle to form, a second threaded drive.

29. The readjustment device as claimed in claim 28, wherein
the second threaded drive converts a torque of the threaded shaft into a translationally acting force which acts on the at least one brake pad and on the brake disc of the disc brake.

30. The readjustment device as claimed in claim 27, wherein
the output wheel is connected rotationally conjointly to the threaded spindle.

31. The readjustment device as claimed in claim 30, wherein
the second threaded drive is formed by the threaded spindle and by an internal thread in a thrust piece or an internal thread in a pad plate of the brake pad or an internal thread in a further component.

32. The readjustment device as claimed in claim 31, wherein
the sleeve has multiple output elements on its circumference, wherein the output elements are each designed in the manner of a toothing profile.

33. The readjustment device as claimed in claim 32, wherein
a torque, introduced into the sleeve, of the threaded shaft is transmitted by the output elements via transmission elements to the internal profile of the output wheel.

34. The readjustment device as claimed in claim 33, wherein
the first resetting spring is supported with its upper end in a transition between an inner side of the piston crown and the collar and with its lower end on an upper bearing ring.

35. The readjustment device as claimed in claim 34, wherein
the upper bearing ring, with the drive disc and rolling bodies, forms a first rolling bearing by which the drive disc is rotatably mounted.

36. The readjustment device as claimed in claim 35, wherein
a second rolling bearing by which the drive disc is rotatably mounted is formed by a lower bearing ring and rolling bodies.

37. The readjustment device as claimed in claim 36, wherein
the first coupling is a first ball ramp coupling.

38. The readjustment device as claimed in claim 37, wherein
the second coupling is a second ball ramp coupling.

39. The readjustment device as claimed in claim 38, wherein
the readjustment device has a further resetting spring.
